(19) United States
(12) Patent Application Publication
(10) Pub. No.: US 2026/0079038 A1
(43) Pub. Date: Mar. 19, 2026

(54) PIT SENSOR

(71) Applicant: XORRO PTY LTD, Osborne Park, Western Australia (AU)

(72) Inventor: Leonard LUXFORD, Osborne Park (AU)

(21) Appl. No.: 19/109,997

(22) PCT Filed: Sep. 8, 2023
(86) PCT No.: PCT/AU2023/050870

§ 371 Date: Mar. 7, 2025

(30) Foreign Application Priority Data
Sep. 8, 2022 (AU) 2022902596

(51) Int. Cl. G01F 23/284; G01J 1/42

(52) U.S. Cl. CPC G01F 23/284; G01J 1/4204

(57) ABSTRACT

A sensor device for a pit having an opening comprises a light level detector configured to measure light entering the pit through the opening, and/or a distance sensor configured to determine a distance from the sensor to a water or content level within the pit. The sensor device also comprises a processor for interpreting the measured light and/or water or content level and prepares a transmission signal, and a transmitter of the transmission signal. The detector, processor and transmitter are housed within a package.

### FIELD OF THE INVENTION

The present invention relates to a sensor for detecting properties of a pit.

More particularly, the present invention relates to a sensor detecting the level of water or blockage of a pit, such as a stormwater pit.

### BACKGROUND

The following discussion of the background art is intended to facilitate an understanding of the present invention only. It should be appreciated that the discussion is not an acknowledgement or admission that any of the material referred to was part of the common general knowledge as at the priority date of the application.

Drainage systems, including stormwater pits sometimes termed drains, are exposed to numerous deficiencies in part due to the infrequency or magnitude of rainfall events.

Large magnitude rainfall events can cause drainage systems to be filled beyond capacity and overflow.

Debris can be washed into drainage systems and cause blockages (to the entry, exit pipes and within) which may affect the drainage capability.

The present invention has been developed within the context of this background.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### SUMMARY OF THE INVENTION

Systems and methods for monitoring, analysing, collecting and networking contents of stormwater pits are disclosed herein. A method for the analysis and comparison of contents of one or more stormwater pits is also disclosed.

According to an aspect of the present invention there is provided a sensor device for a pit having an opening, the device comprising:
a light level detector configured to measure light entering the pit through the opening,
a processor for interpreting the measured light and preparing a transmission signal;
a transmitter of the transmission signal;
wherein the detector, processor and transmitter are housed within a package.

Typically, the opening is into a street and the opening is in a side of the pit so that stormwater from the street can enter the stormwater pit and be carried away through stormwater pipes leading from the stormwater pit.

According to an aspect of the present invention there is provided a sensor device for a pit, the device comprising:
a distance sensor configured to determine a distance from the sensor to a water or content level within the pit, wherein the distance sensor comprises a radio frequency (RF) radiation emitter and receiver;
a processor for interpreting the determined water level and preparing a transmission signal;
a transmitter of the transmission signal;
wherein the distance sensor, processor and transmitter are housed within a package.

According to an aspect of the present invention there is provided a sensor device for a pit having an opening, the device comprising:
a light level detector configured to measure light entering the pit through the opening,
a distance sensor configured to determine a distance from the sensor to a water or content level within the pit,
a processor for interpreting the measured light and water or content level and preparing a transmission signal;
a transmitter of the transmission signal;
wherein the detector, processor and transmitter are housed within a package.

In an embodiment, the package is configured to be located proximal an upper portion of a pit. In an embodiment, the package is located on a roof of the pit.

In an embodiment, the measured light is an indication of light or no light.

In an embodiment, the measured light comprises an amount of light, wherein the processor interprets the amount of light and defines an amount that indicates whether the pit is blocked. In an embodiment, the processor takes account of the time of day or of a day/night cycle. In an embodiment, interpretation is of no or low light over an extended period during the day is an interpretation of a blockage of the opening.

In an embodiment, the distance sensor is configured to emit a radiation and receive a reflection of the radiation, wherein the reflected signal is produced by reflection or similar of contents of the pit. In an embodiment, the radiation is RF radiation. In a preferred embodiment, the radiation is RADAR.

In an embodiment, the sensor device comprises a sensor of water entering the pit. In an embodiment, the distance sensor operates as the sensor of water entering the pit. In an embodiment, the distance sensor comprises a first lens for receiving the reflected signal and a second lens for receiving reflection of water entering the pit. In an embodiment the first lens views towards the bottom of the pit. In an embodiment the second lens views towards a path of water entering the pit through the opening and moving towards the bottom of the pit. In an embodiment the first lens focuses RF radiation. In an embodiment the second lens focuses RF radiation.

In an embodiment the distance sensor is configured to measure flow rate of water moving in the pit. In an embodiment the sensor of water entering the pit is configured to measure flow rate of water entering the pit.

In an embodiment, the device further comprises a power source for powering at least one of the distance sensor and/or light detector (depending on the embodiment), processor and transmitter; wherein the power source is also housed in the package. The power source may be a battery, such as a long life lithium battery. Alternatively, the power source is mounted externally to the pit. In this case the power source may comprise one or more solar cells.

In an embodiment the distance sensor looks through an aperture in the package into the interior of the pit. In one form the aperture may be a hole, on another form the aperture may be solid, but transparent or translucent. In one form the aperture may be solid, but transparent to the type of radiation emitted by the distance sensor. In embodiment the aperture may comprise a lens.

In an embodiment the distance sensor comprises an emitter capable of emitting a type of radiation. In an embodiment the type of radiation is selected from: laser for a LIDAR detector, ultrasonic, infrared light, xray, or microwave. In an embodiment the microwave is used for RADAR.

In an embodiment the distance sensor further comprises another emitter capable of emitting another type of radiation. In an embodiment the other types of radiation are selected from: laser for a LIDAR detector, ultrasonic, infrared light, xray, or microwave.

In an embodiment the radiation is configured to scan the inside of the pit to sense a surface defined by contents of the pit. In an embodiment the radiation is reflected and the reflection signal is processed to determine the level of the water and/or the contents of the pit.

In an embodiment the processor is configured to determine the characteristics of and/or the type of material detected in the pit. In an embodiment the emitted radiation is RADAR and the type of material is determined according to the reflection. In an embodiment, the type of material is determined to be a type of debris in water. In an embodiment, the characteristics comprise a rate of flow.

According to an aspect of the present invention there is provided a sensor system for a drainage system, the sensor system comprising a plurality of sensor devices, wherein each device comprises; a light level detector configured to measure light entering the pit through the opening, a processor for interpreting the measured light and preparing a transmission signal; and a transmitter of the transmission signal.

According to an aspect of the present invention there is provided a sensor system for a drainage system, the sensor system comprising a plurality of sensor devices, wherein each device comprises; a distance sensor configured to determine a distance from the sensor to a water or content level within the pit, a processor for interpreting the determined water level and preparing a transmission signal; and a transmitter of the transmission signal.

According to an aspect of the present invention there is provided a sensor system for a drainage system, the sensor system comprising a plurality of sensor devices, wherein each device comprises; a light level detector configured to measure light entering the pit through the opening, a distance sensor configured to determine a distance from the sensor to a water or content level within the pit, and a processor for interpreting the measured light and determined water or content level and preparing a transmission signal, and a transmitter of the transmission signal.

In an embodiment the processor sends determinations as to fill level and/or contents to a server.

In an embodiment the processor sends determinations as to blockage of a pit opening to a server.

In an embodiment the processor sends determinations as to flow rate of water in the pit to a server.

In an embodiment the processor cooperates with a networked processor to share processing.

In an embodiment the processor receives a location signal, such as from a GPS system.

In an embodiment the server uses determinations from other processors of other pits and/or is configured to make collective determinations about groups of pits. In an embodiment this is facilitated by each pit (or each sensor device for each pit) being uniquely identified. In an embodiment this is facilitated by each pit's location being known. In an embodiment this is facilitated by each event having a time stamp recorded against it.

In an embodiment the server is configured to send a control signal to a value or gate in a stormwater drainage system based on one or both of the level of water in the pit and the flow rate of water in the pit.

The method can include calculation by the server system whether to include the pit in a route data set defining a route. The calculation is determined according to the determined blockage of the pit.

The method can include creating the route data set and wirelessly sending the route data set from the server system to a mobile device.

In an embodiment the processor cooperates with a networked processor to share processing.

According to an aspect of the present invention there is provided a method of determining whether an aperture of a pit is blocked using a light level detector, the method comprising;
a. Taking at least one light level reading per day using the light level detector at a time of day when there is daylight outside of the pit,
b. In the event that the reading does not identify sufficiently high light level, identifying the pit as blocked.

According to an aspect of the present invention there is provided a method of determining whether an aperture of a pit is blocked, the method comprising;
a. Using an aperture detection means to check the aperture intermittently,
b. In the event that the check indicates blockage, identifying the pit as blocked.

In an embodiment, the aperture detection means is a light level detector located within the pit.

In an embodiment, the light level detector is comprised within a sensor device as described herein.

In an embodiment, the aperture detection means comprises an external signal emitter and a reflector, wherein the reflector is located within the pit and the signal emitter is external.

In such an embodiment, the signal emitter may be configured to carry out intermittent on multiple pits, each pit comprising a reflector.

According to an aspect of the present invention there is provided a method of detecting the level of water or contents in a pit, the method comprising;
a. Using a RADAR distance sensor located proximal an upper portion of the pit to measure distance to a water or content level and provide a reading,
b. Using a transmitter to transmit the reading wirelessly.

In an embodiment the RADAR distance sensor measures a characteristic of the water. In an embodiment the characteristic comprises one or more of the flow rate of the water, an amount of any contents in the water and a type or types of any contents in the water.

In an embodiment a sensor detects water entry into the stormwater pit through an opening in the upper portion. In an embodiment the sensor measures a characteristic of the water entering the pit through the opening. In an embodiment the characteristic of water entering through the opening comprises one or more of the flow rate of the water, an amount of any contents in the water and a type or types of any contents in the water.

According to an aspect of the present invention there is provided a method of calibrating a sensor device for detecting the level of water or contents in a pit, the method comprising;
a. affixing a distance sensor located proximal an upper portion of the pit at a time when a bottom of the pit is visible,
b. using the distance sensor to take a distance reading to the bottom of the pit,
c. recording the reading as the bottom of the pit.

According to an aspect of the present invention there is provided a method of detecting the level of water and other contents in a pit using a distance sensor comprising at least two emitters capable of emitting different types of radiation, the method comprising;
a. Measuring distance to a water level using reflected radiation from a first emitter and providing a reading,
b. Measuring distance to other contents using reflected radiation from a second emitter and providing a reading,
c. Using a transmitter to transmit the water level reading and other content level reading wirelessly.

According to an aspect of the present invention there is provided a method of control of a stormwater network comprising, for each pit: Determining whether the pit is blocked using a light level detector; Determining the level of water in the pit.

In an embodiment the method further comprises controlling the flow of water in the network according to the determination of whether one of the pits is blocked and/or the determination of the level of water in each pit.

In an embodiment the method further comprises determining the flow rate of water in each pit.

In an embodiment the method further comprises controlling the flow of water in the network according to the flow of water in each pit.

In an embodiment the method further comprises visualising the state of each pit.

### DESCRIPTION OF DRAWINGS

In order to provide a better understanding, embodiments of the present invention will be described, by way of example only, with reference to the accompanying drawings, in which:

FIG. 1 is a perspective view of a pit having an opening, with a sensor device 10 according to an embodiment of the invention located on an underside of the pit cover.

FIG. 2 is an elevation looking through an opening of the pit, with a sensor device 10 according to an embodiment of the invention located on an underside of the pit cover.

FIG. 3 is a section through a pit having an opening, with a sensor device according to an embodiment of the invention located on an underside of the pit cover.

FIG. 4 is a section through a pit having an opening, with a sensor device 10 according to an embodiment of the invention located on a back wall of the pit.

FIG. 5 is a view showing a sensor device 10 according to an embodiment of the present invention, the embodiment comprising a light level detector 20.

FIG. 6 is a view showing a sensor device 10 according to an embodiment of the present invention, the embodiment comprising a distance sensor 30.

FIG. 7 is a view showing a sensor device 10 according to an embodiment of the present invention, the embodiment comprising a light level detector 20 and a distance sensor 30.

### DESCRIPTION OF EMBODIMENTS

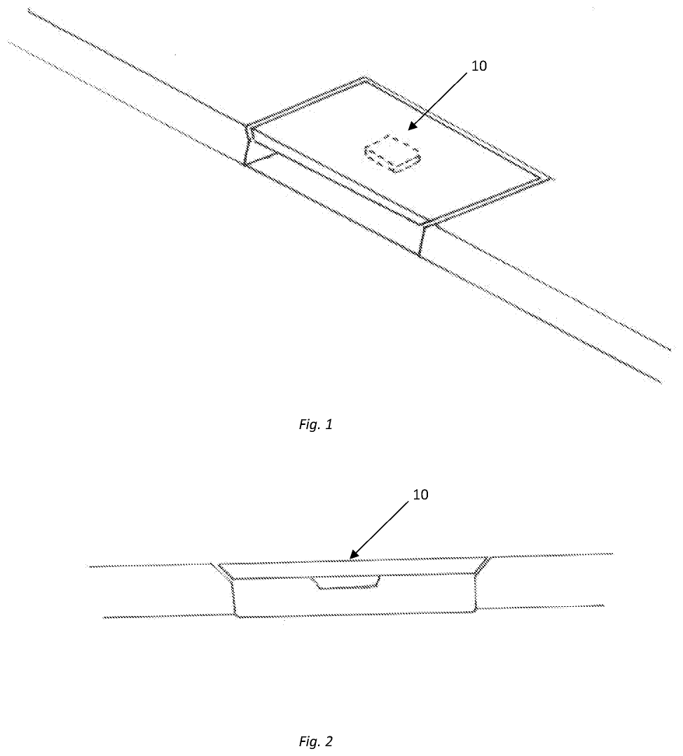

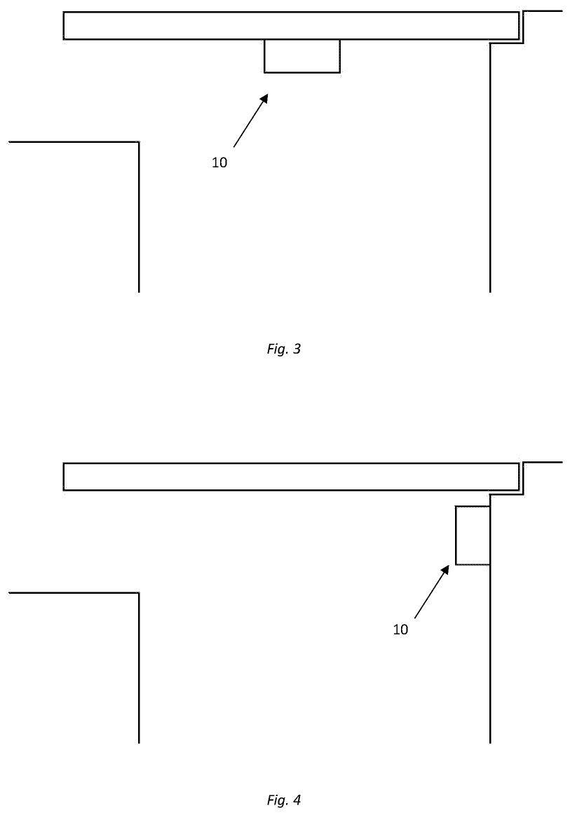

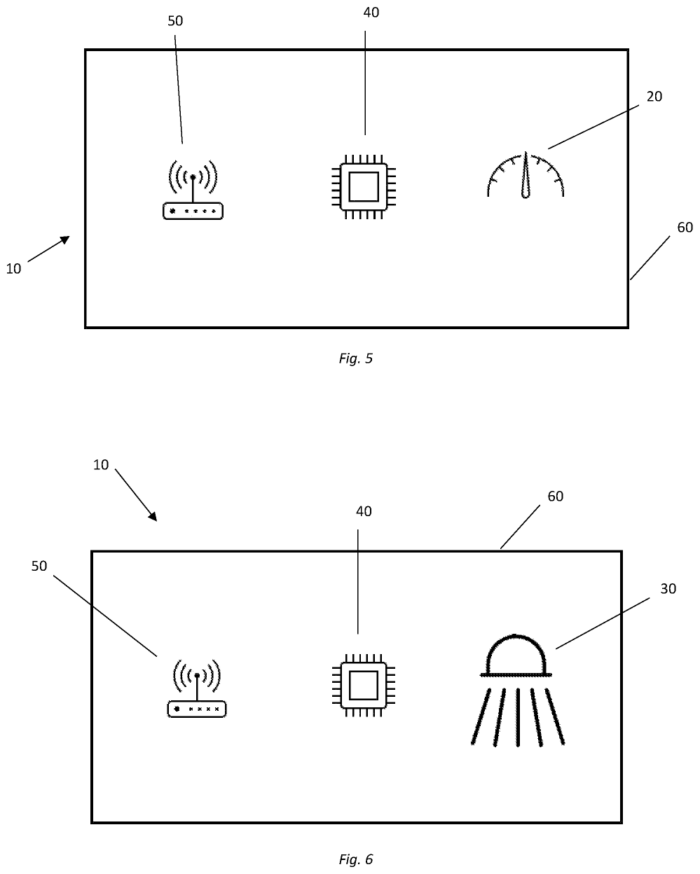

Referring to FIGS. 1 to 4 there is shown a pit, such as a stormwater pit having an opening and a sensor device 10 according to an embodiment of the invention. The invention may also be suitable for other types of pit. The sensor device 10 is located on an underside surface of a stormwater pit cover in FIGS. 1 to 3, and on a rear wall of the stormwater pit in FIG. 4.

The location of the sensor device 10 can be anywhere that the person skilled in the art would understand to be capable of performing the required function.

Referring to FIG. 5, there is shown a sensor device 10 according to a first embodiment of the invention, the sensor device 10 comprising; a light level detector 20 configured to measure light entering the stormwater pit through the opening; a processor 40 for interpreting the measured light and preparing a transmission signal; a transmitter 50 of the transmission signal; wherein the detector 20, processor 40 and transmitter 50 are housed within a package 60.

The capability to detect a light level is advantageous. Debris, such as leaves and rubbish, may be washed into a stormwater pit during a large rain event. In cases where the amount of debris is sufficient to block the stormwater pit opening, thus preventing the stormwater pit from functioning, at least to full capacity, the lack of ambient daylight in the stormwater pit is a good indicator that the opening is blocked.

The light level detector 20 may be configured to measure light intermittently or periodically, which may reduce power usage. Frequency of the readings may vary depending on various factors, for example geographical location, perceived likelihood of blockage or disruption or impact of blockage. Where a stormwater pit is more prone to blockage, or more prone to cause significant inconvenience when blocked, for example on a busy street, the detector 20 may be configured to take readings more frequently than light level detectors 30 on other stormwater pits. A signal may be sent to the detector 20 comprising a parameter to set the timing of light detection/blockage detection. The signal may comprise a weather parameter such that light levels detected can be compared to an expected light level for the weather conditions. For example, bright light would be expected on a clear sunny day. Lower light levels would be expected on an overcast day and dim light levels would be expected on a rainy/stormy day. Light levels for the conditions may be learnt by the sensor. Additionally expected night time light levels (such as from street lighting) may used as a comparison to determine whether there is a blockage of the opening. Also such measurements as light and rain levels can be taken from nearby weather stations and rain gauges for further reference to determine that water should be entering the stormwater pit but is not being detected as entering.

The detector may have or receive a time of day clock signal. The processor 40 can take account of the time of day or of a day/night cycle. In an embodiment, interpretation is of no or low light over an extended period during the day is an interpretation of a blockage of the opening. It is considered that one to three daily measurements would be sufficient to indicate whether a stormwater pit is blocked. Other timings are possible, such as every min, 5 min, 15 min, or hour, for example. Once daily may be sufficient where it can be certain that the measurement is taken during daylight hours (so that darkness is not mistaken for a blocked stormwater pit), or two or three times daily may be preferred to avoid this issue, where two or three consecutive measurements that indicate a low level may then constitute a blocked stormwater pit.

The information of a blocked stormwater pit may be useful for a variety of reasons. It is considered to be primarily used to indicate where and when a street sweeper, or other means to clear the blockage, may be deployed. However longer term data may also be useful in planning stormwater management of the area and even to provide a broader understanding, for example where current design guidelines may be deficient.

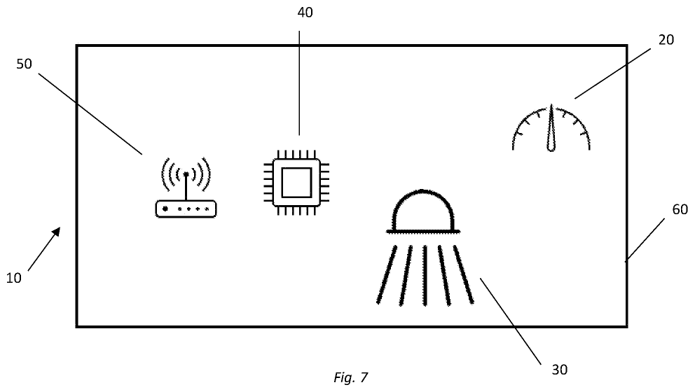

Referring to FIG. 6, there is shown a sensor device 10 according to a second embodiment of the invention, the sensor device 10 comprising; a distance sensor 30 configured to determine a distance from the sensor 30 to a water or content level within the stormwater pit; a processor 40 for interpreting the determined level and preparing a transmission signal; a transmitter 50 of the transmission signal; wherein the distance sensor 30, processor 40 and transmitter 50 are housed within a package 60.

The capability to determine the water level within a stormwater pit is advantageous, in a large and complex stormwater drainage system there may be options available to redirect flow of water where a stormwater pit is overflowing, or about to overflow.

The sensor device 10 comprising a distance sensor 30 enables the determination of water levels within all the stormwater pits in which sensor devices 10 are installed. This information provides a clear indication of the capacity and bottlenecks within a large system, which would otherwise be unavailable. An increasing level of water in the stormwater pit may be used as a predictor or indicator of flooding.

Referring to FIG. 7, there is shown a sensor device 10 according to a third embodiment of the invention, the sensor device 10 comprising; a light level detector 20 configured to measure light entering the stormwater pit through the opening; a distance sensor 30 configured to determine a distance from the sensor 30 to a water or content level within the stormwater pit; a processor 40 for interpreting the measured light and determined water or content level and preparing a transmission signal; a transmitter 50 of the transmission signal; wherein the detector 20, distance sensor 30, processor 40 and transmitter 50 are housed within a package 60. This embodiment may perform as a combination of the first and second embodiments.

Unless the contrary is apparent, embodiments of the above-described principal aspects, and any of those described below, may comprise or incorporate, either individually or in combination, any of the following features.

The package 60 may be configured to be located proximal an upper portion of a stormwater pit.

The distance sensor 30 may be oriented in a first direction (for example down the stormwater pit when installed) and the light level detector 20 may be oriented in a second direction (for example toward the stormwater pit opening when installed). The directions may be substantially at an acute angle (eg. 30 degrees, 45 degrees, 60 degrees) or orthogonal to each other.

The package 60 may comprise a housing formed, at least in part, of a transparent or translucent material, so that the light level detector 20 is able to function whilst inside the package 60

Any of the preceding embodiments may be comprised in a sensor system 100, comprising a plurality of sensor devices 10, wherein the types of sensor devices 10 comprises may be any of the embodiments, alone or in combination, to suit the requirements of the sensor system 100.

In such a system 100 the sensor devices 10 may be attached to different stormwater pits, wherein the stormwater pits and the types of sensor devices 10 may be selected according to criteria such as the location of the stormwater pit and likelihood of a stormwater pit to become blocked or overflow.

The light level detector 20 and/or distance sensor 30 may operate under the control of a controller (not shown). The controller may be part of the processor 40.

The light level detector 20 and/or distance sensor 30 and controller may be formed into a single package. In an embodiment the sensor device 10 further comprises a power source for powering at least one of the light level detector 20 and/or distance sensor 30, processor 40 and transmitter 50.

The sensor device 10 may further comprises a package 60 for housing the light level detector 20 and/or distance sensor 30, processor 40, transmitter 50 and power source.

The package 60 may be integrally formed with, in or on a portion of a stormwater pit cover. In an embodiment the package 60 may be attached to the stormwater pit (for example to the cover) by screws or glue.

The distance sensor 30 may be configured to emit and receive a reflected signal, wherein the reflected signal is produced by reflection or similar of contents of the stormwater pit.

The distance sensor 30 may look through an aperture into the interior of the stormwater pit. In one form the aperture may be a hole, in another form the aperture may be solid, but transparent or translucent. In one form the aperture may be solid, but transparent to the type of radiation emitted by the distance sensor 30.

The distance sensor 30 may comprise an emitter capable of emitting one or more types of radiation. The types of radiation may be selected from: laser for a LIDAR detector, ultrasonic, infrared light, xray, or microwave for RADAR.

RADAR is Radio Detection and Ranging, which uses radio frequency transmission, such as pulses, to detect and measure the distance between a source (the RF emitter) and a reflecting object (in this case the base of the stormwater pit or water in it).

In an embodiment the RF radiation is pulsed coherent microwave radiation, for example at 60 GHz. An integrated antenna in package chip provided by Sense™ can be used which is available with a range of about 10 m and millimetre accuracy. An alternative sensor is Acconeer A121. The package can transmit a half power beamwidth with a H plane window of 80° and an E plane of 40°. The reflected RF radiation beam can be focused with a Freznel zone plate lens between 3 and 8 mm form the detector antenna. The lens need to be pointed at the target object. Detection is determined by meeting a threshold reflectance. The transmitted pulse takes time to reach the reflective object and return for detection. The distance of the object is determined by a time of flight calculation:

$$d = ( {c}^{*} t ) / 2 ,$$

where d is the distance from the emitter and receiver to the object, c is the speed of light in atmosphere, and tis the time taken between transmission and detection of the pulse. Thus, if the time is 6.67 ns, the distance will be 1 m.

As discussed in ‘Fluid Surface Velocity Measurement using Millimetre-Wave Radar Sensor’ G. Broman & L. G. Nilsson Master's thesis publication 21 Jun. 2022, the contents of which is incorporated herein by reference, the received signal will have spectral components that can be used to determine the velocity of movement of the reflecting object. When that is water the surface velocity of the water can be determined. An FFT is used to determine the spectral components. From the squared absolute value of the FFT power special density (PSD) which is the power density of the signal at component frequencies, can be calculated. Doppler shift effect can then be used to determine the velocity from the frequencies of the spectral components in the PSD using phase difference between sweeps, where sweeps are made over several distance sampling points. Doppler frequency can be used to calculate velocity using:

$${f}_{D} = - f 2 {v}_{r} / c ,$$

where f_{D} is the Doppler (measured) frequency, f is the transmitted frequency, and v is the velocity.

Thus, to measure surface velocity the emitter antenna and focused receiver antenna need to be pointed toward the bottom of the stormwater pit and at a known or calculated angle such that the viewed velocity can be used to calculate the surface velocity.

A plot of different velocities over the area of the water in the stormwater pit can reveal a foreign object.

The same approach can be used to detect and measure the velocity of water entering the opening into the stormwater pit instead of water at the bottom of the stormwater pit, where the path of water moving from the opening can be targeted.

It is also known that different materials have different reflectance of microwave radiation. Based on the reflectance the type of material in the stormwater pit or in water in the stormwater pit can also be determined. For example, an aluminium can will have a different characteristic reflectance, which can be used to determine that it have entered the stormwater pit. Plastics also have different characteristic reflectance and the same can be used to detect a plastic material has entered the stormwater pit.

The distance sensor 30 may further comprise another emitter capable of emitting another type of radiation. In an embodiment the other types of radiation are selected from: laser for a LIDAR detector, ultrasonic, infrared light, xray, or microwave. The other detectors can be used to enhance the first detector by use of different spectral reflectance qualities.

The processor 40 may send determinations as to fill level and/or contents to a server 200.

The processor 40 may send determinations as to blockage of a stormwater pit opening to a server 200.

The server 200 may send commands/operating parameters to the processor 40 in a signal.

The processor 40 may cooperate with a networked processor to share processing.

The processor 40 may receive a location signal, such as GPS.

The server 200 may use determinations from other processors 40 of other stormwater pits and/or is configured to make collective determinations about groups of stormwater pits. This may be facilitated by each stormwater pit being uniquely identified. This may be facilitated by each stormwater pit's location being known. This may be facilitated by each event having a time stamp recorded against it. The server 200 may be configured to send a control signal to a value or gate in a stormwater drainage system based on one or both of the level of water in the stormwater pit and the flow rate of water in the stormwater pit to control water in the stormwater drainage system.

In an embodiment the sensor system 100 employs a learning/artificial intelligence (AI) algorithm. In an embodiment the system 100 applies data available to it to determine what actions to take. For example, deploying street sweepers, or diverting storm water, issue of a flood warning or activating pumping, valves or gates to control the flow of water. The action may take account of collective consideration of a plurality of stormwater pit data. For example, as a flood progresses from one region to another the sensors will progressively detect increased filling of stormwater pits to the point of overflow. The direction of travel of a floor, the speed of travel of water and the amount of water involves could be determined from the sensor data from the sensors and appropriate planning of countermeasures taken and warnings issued.

In an embodiment the AI algorithm is trained using external data. Eg weather data and/or security camera footage.

The AI algorithm may learn and anticipate water levels throughout the system 100, for example during a large rain event, and predict required action, for example using weather forecast data.

The information obtained of from the sensor system 100 may be used to visualise the system as a whole on a displayed map for future planning or emergency reaction planning purposes. The system 100 may draw upon other information, which as data from weather stations positioned proximal to nearby stormwater pits.

Neural Radiance Fields may be used to visualise the what is occurring in one or more stormwater pits by using a Multi-layer Perceptron (MLP) to map 3D locations to colour and volume density that represent stormwater pits along with RADAR point cloud signed distance functions (SDF). The visualisation simulates reconstruction of stormwater pits from photographic images to compose stormwater pit and network/system schematic renderings that can be shown with updating water levels shown in the simulated stormwater system. Water volumes within the system and be estimated, as can discharge, which may also be controlled according to water volumes at different locations.

The system may work similarly to that of WO2014063184 but with additional or alternative sensors as described herein. The routing of a waste collector or a maintenance person may work similarly to that of WO2014063184 but with determinations and/or decisions about the contents or state of the container or events occurring to/in/on or around the container as described herein. Equally WO2019/040946 or EP 3415947 (the contents of which are incorporated here by reference) individually in place of WO201403184 or collectively with each other and/or with WO201403184.

The processor may be a microprocessor controlled by one or more computer programs, which comprise instructions stored in a non-volatile manner (eg in firmware or solid state storage) which when executed cause the processor to operate according to one or more of the embodiments as described herein.

The power source may be a battery, such as a long life lithium battery. The power source may comprise one or more solar cells.

The processor of each sensor may be configured to monitor to a rapid increase in water or contents level and contract the server in that event.

When two types of emitter and detector are used in the sensor one can be used to detect water, the other to detect other contents, such as debris (eg leaves). When no water is detected but the level of contents is still above the bottom level, then the contents may be regarded as dry.

The transmitter may be a cellular telephone network transmitter, WiFI, Bluetooth, LoRa or other transmitter. Transmitters may be configured to diary chain transmitter or can capacity to skip a hop if necessary to provide redundancy.

Modifications and variations as would be apparent to a skilled person are intended to be covered by the present invention.

1-26. (canceled)

27. A sensor device for a pit, the device comprising:
a distance sensor configured to determine a distance from the sensor to a water or content level within the pit, wherein the distance sensor comprises a radio frequency (RF) radiation emitter and receiver;
a processor for interpreting the distance and preparing a transmission signal;
a transmitter of the transmission signal;
wherein the distance sensor, processor and transmitter are housed within a package.

28. The sensor device according to claim 27, wherein the distance sensor is configured to measure flow rate of water moving in the pit.

29. The sensor device according to claim 27, wherein the sensor device comprises a sensor of water entering the pit.

30. The sensor device according to claim 27, further comprising a light level detector configured to measure light entering the pit through an opening in the pit.

31. The sensor device according to claim 30, wherein the processor is configured to:
interpret the measured light; and
include in the transmission signal the interpretation of the measured light.

32. The sensor device according to claim 30, wherein:
the opening in the pit is also in a street and is in a side of the pit such that light enters at an acute angle to a bottom of the pit relative to a position of a housing,
the light level detector and the distance sensor are housed within the housing that is located on a roof of the pit, and
the light level detector is arranged to receive light from the opening and the distance sensor is arranged to measure the light in a direction of the bottom of the pit.

33. The sensor device according to claim 27, wherein the distance sensor comprises:
a first lens facing towards a bottom of the pit; and
a second lens facing towards a path of water:
entering the pit through an opening in the pit; and
moving towards the bottom of the pit.

34. The sensor device according to claim 29, wherein the processor is configured to interpret readings from the distance sensor to determine the presence of debris in water entering the pit or in water travelling through the pit.

35. A sensor system for a drainage system, the sensor system comprising:
a plurality of sensor devices, wherein each device comprises:
a distance sensor configured to determine a distance from the sensor to a water or content level within a pit, wherein the distance sensor comprises a radio frequency (RF) radiation emitter and receiver;
a processor for interpreting the distance and preparing a transmission signal; and
a transmitter of the transmission signal.

36. The system according to claim 35, further comprising a receiver of the transmission signal of each sensor device, and a processor of the received signals.

37. The system according to claim 36, wherein the processor is configured to monitor a status of the drainage system.

38. The system according to claim 37, wherein the processor is configured to make determinations from a plurality of pits in order to make collective determinations about the plurality of pits.

39. The system according to claim 35, wherein the processor is configured to send a control signal to a valve or gate in a stormwater drainage system based on one or both of the level of water in the pit or a plurality of pits and a flow rate of water in the pit or the plurality of pits.

40. The system according to claim 39, wherein the processor is configured to redirect the flow of water through the stormwater drainage system to address a possible overflow in the stormwater drainage system.

41. The system according to claim 35, wherein the processor is configured to use a detection of increasing level of water (rate of change of level) to predict a possible flood event.

42. The system according to claim 41, wherein the processor is configured to control the drainage system to mitigate against the possible flood event.

43. A method of detecting a level of water or contents in a pit, the method comprising:
using an RF distance sensor located proximal an upper portion of the pit to measure a distance to a water or content level and provide a reading; and
using a transmitter to transmit the measurement wirelessly.
